(19) United States
(12) Patent Application Publication
(10) Pub. No.: US 2005/0102619 A1
(43) Pub. Date: May 12, 2005

(54) Document processing device, method and program for summarizing evaluation comments using social relationships

(75) Inventors: Yoshinori Hijikata, Takatsuki City (JP); Hanako Ono, Ikeda City (JP); Yukitaka Kusumura, Kyotanabe City (JP); Shogo Nishida, Takarazuka City (JP)

Correspondence Address: OLIFF & BERRIDGE, PLC, P.O. BOX 19928, ALEXANDRIA, VA, 22320, US

(73) Assignee: OSAKA UNIVERSITY, Suita City (JP)

(21) Appl. No.: 10/841,605

(22) Filed: May 10, 2004

(30) Foreign Application Priority Data
Nov. 12, 2003 (JP) 2003-382769

(51) Int. Cl. G06F 17/00

(52) U.S. Cl. 715/530; 707/6

(57) ABSTRACT

A document processing device 100 is provided, the device 100 comprises an accessing part 110, a collecting part 120, a morpheme analysis part 130, an extracting part 140, a storing part 150, and a displaying part 160. The collecting part 120 collects evaluation comments aiming at a certain evaluation subject as a first evaluation comment group from the database 180, and collects evaluation comments, in which these evaluation comments are comments on evaluation subjects other than the said certain evaluation subject by valuers who provided evaluation comments on the said certain evaluation subject as a second evaluation comment group from the database 180. The morpheme analysis part 130 segments sentences included in the said first and second evaluation comment groups into pairs of an attribute having at least one predetermined keyword and an attribute value having at least one part of speech regarding the attribute using a morpheme analysis technique. The extracting part 140 compares the pairs of the said first evaluation comments group with the pairs of the said second evaluation comments group by each valuer, and to extract one or more pairs, which exist only in the said first evaluation comment group, as a presence summary. Also the extracting part 140 extracts one or more pairs, which exist only in the said second evaluation comment group, as a non-presence summary by the comparison.

### BACKGROUND OF THE INVENTION

1. Field of the Invention

The present invention relates to a document processing device, method and program for summarizing evaluation comments using social relationships, and more particularly to a system, method and program for automatically summarizing review comments i.e., evaluation comments on sellers or exhibitors in e-commerce such as online-auction sites according to each buyer i.e., a winning bidder who provided comments by investigating statistics values about descriptions or expression in the comments according to each buyer.

2. Related Art Statements

Nowadays a many number of electric business transactions regarding various items or services have been performed over the Internet. There are many kinds of transactions and commercial services. Online-auction among them has grown in popularity because general public users (i.e., amateurs) can exhibit his or her own items. In general, auction sites let a winning bidder to write a review comment, hereinafter which is referred as “an evaluation comment(s)”, on an exhibitor (seller) who exhibited and sold an item or a service to the bidder. Other public users can access evaluation comments for reference and thus they can easily determine an item to be submitted bids or a seller who exhibits an item based on the review comments. However, in these days there are huge number of evaluation comments on the Internet, users need considerable work and time for looking through all evaluation comments on the Web or Internet.

In order to resolve this problem, what is necessary is just to make summaries of evaluation comments for presenting them to users. However, the evaluation comments include not only comments presenting real opinions of winning bidders on exhibitors but also many stereotyped sentences/phrases/expressions/words such as expressions for thanks or commonly-used many expressions of courtesy. Since such expressions for thanks or expressions of courtesy have mostly no useful or no meaningful information, it is useful for users to eliminate such no meaningful information and to extract only important pieces of information for representing them as a summary to users.

However, since conventional general summarizing approaches regard that descriptions having higher appearance frequencies are important, these conventional techniques generate a summary based on this concept so that such no useful descriptions might be remained therein. Under such conventional approaches, there is a problem that the summary includes a many number of sentences, phrases or expressions for thanks or expressions of courtesy described above. In addition, even if there are descriptions, which are very important for users but frequencies of which are lower, it is a problem that these useful descriptions will be eliminated and thus cannot remain in the summary.

Some of other conventional summarizing techniques utilize frequencies and positions of keywords, layout information, and emphasized words in documents to be summarized, and to provide each part in a document with importance to extract some sentences or expressions to be included in a summary from the documents. However in these techniques expressions for thanks or expressions of courtesy also cannot be deleted or excluded from the summary and deliberately avoided sentences or expressions in documents cannot be presumed, in other words the avoided sentences or expressions in documents may not be extracted.

There are other conventional document summarizing techniques for documents in networks, which documents are written by the general public, such as a MHC-Message Harmonized Calendaring System (refer to a Japanese document: Y. Nomura, et al, “Design and Implementation of MHC-Message Harmonized Calendaring System”, Journal of Information Processing Society of Japan (ISPJ) Vol. 42, No. 10, pp. 2518-2525, 2001), a technique by M. Satoh (refer to a Japanese document: M. Satoh, et al, “Automatic producing of digest form e-news”, Journal of Information Processing Society of Japan (ISPJ) Vol. 36, No. 10, pp. 2371-2379, 1995), a technique by S. Satoh (refer to a Japanese document: S. Satoh, et al, “Automatic producing of digest form a net news group of fj.wanted”, Natural Language Processing Vol. 3, No. 2, pp. 19-32, 1996), a CIKLE technique by Umeki (refer to a Japanese document: H. Umeki, et al, “Community-Ware Using Knowledge buried in communications”, Journal of Information Processing Society of Japan (ISPJ) Vol. 43, No. 10, pp. 1085-1092, 2002). In these conventional approaches particular keywords or symbols are used for extracting or eliminating some pieces of information. Therefore, content of the information to be extracted or eliminated are fixed. It is conceivable that these conventional approaches are utilized for summarizing evaluation comments in network auction using fixed rules to eliminate description which can be qualified as the above-described expressions for thanks or commonly-used many expressions of courtesy. However, when such fixed or static rules are employed and there are descriptions which include certain sentences or expression of speculative or emotional special thinking for exhibitors by winning bidders, if such special description can be classified with the category of commonly-used sentences or expressions of courtesy, such certain sentences or expression including useful information will be deleted from the summary by the rule and thus useful and meaningful pieces of information may not be extracted as the summary.

### SUMMARY OF THE INVENTION

It is an object of the present invention to provide a document processing device, method and program for summarizing evaluation comments using social relationships.

In order to solve the above mentioned problems, there is provided a document processing device for summarizing evaluation comments using social relationships, the device comprises:
accessing means for accessing a database, in which evaluation comments on a plurality of evaluation subjects by a plurality of valuers are stored therein, via a network (such as the Internet);
collecting means for, when accessing the database, in which evaluation comments on a plurality of evaluation subjects by a plurality of valuers are stored therein for summarizing evaluation comments according to each evaluation subject, collecting evaluation comments aiming at a certain evaluation subject as a first evaluation comment group from the database, and for collecting evaluation comments, which are comments on evaluation subjects other than the said certain evaluation subject by valuers who provided evaluation comments on the said certain evaluation subject, as a second evaluation comment group from the database;
extracting means for comparing the said first evaluation comments group with the said second evaluation comments group by each valuer, and to extract one or more sentences in which the one or more sentences exist only in the said first evaluation comment group as a presence summary and to extract one or more sentences in which the one or more sentences exist only in the said second evaluation comment group as a non-presence summary;
storing means for storing the extracted non-presence summary and the non-presence summary as a summary in a storage or therein; and
displaying means for displaying the extracted non-presence summary and the non-presence summary as a summary.

In the conventional summarizing techniques a summary having only information including individual evaluation subject is just produced, but according to the present invention a summary can be generated from the unprecedented point of view, in other words it is possible to produce a summary in consideration of social relationship (i.e., relative relationship among the plurality of evaluation subject and the plurality of evaluators) by utilizing differences between “an evaluation for a certain evaluation subject” by a certain person and “other evaluations for evaluation subjects other than the certain evaluation subject” by the said certain person. According to the present invention, a description(s) for only a particular evaluation subject (e.g., item, service, merchant, person, company, shop, or restaurant) by a valuer or reviewer can be extracted. This description is a “presence summary”, which includes speculative or emotional special mind for the certain evaluation subject by a valuer and it can be presumed that the “presence summary” represents a real valuer's intention about the certain evaluation subject. In other hand, according to the present invention, a description, which is intentionally excluded for a particular evaluation subject by the valuer and which expression or wording is normally used for review comments by the valuer, can be extracted. This description is a “non-presence summary”. Because the present device extracts “non-presence summary” and to provide users with it, users in e-commerce sites can get to know more accurately about the respective evaluation subjects i.e., persons, items, or services from the extracted “non-presence summary”. Additionally, it can be understood that the “non-presence summary” is not a direct evaluation comment on an evaluation subject but it is an indirect or a potential evaluation comment on the evaluation subject. For example, when information, which is included in a non-presence summary for an evaluation subject, is affirmative or positive, it is projected that evaluation subject is evaluated as negative. On the contrary when information, which is included in a non-presence summary for an evaluation subject, is negative, it is estimated that the evaluation subject is evaluated as affirmative or positive. Namely, owing to the non-presence summary, users in an attempt to make a transaction can read thoughts or minds deep inside of valuers, users can appropriately and efficiently read respective evaluations for evaluation subjects of valuers.

In an embodiment of the document processing device according to the present invention, the device further comprises morpheme analysis means for segmenting or cutting sentences included in the said first and second evaluation comment groups into phrases (phrase is a small group of words which forms a unit) using a morpheme analysis technique (unit),
and wherein the said extracting means compares the phrases of the said first evaluation comments group with the phrases of the said second evaluation comments group by each valuer, and to extract one or more phrases, which exist only in the said first evaluation comment group, as a presence summary, and to extract one or more phrases, which exist only in the said second evaluation comment group, as a non-presence summary.

According to the present invention, due to that a comparison process cab be performed in a phrase unit unlike a sentence unit, summaries are created more accurately.

In another embodiment of the document processing device according to the present invention, the device further comprises morpheme analysis means for segmenting or cutting sentences included in the said first and second evaluation comment groups into pairs, each including an attribute having at least one predetermined keyword and an attribute value having at least one part of speech regarding the attribute, using a morpheme analysis technique,
and wherein the said extracting means compares the pairs of the said first evaluation comments group with the pairs of the said second evaluation comments group by each valuer, and to extract one or more pairs, which exist only in the said first evaluation comment group, as a presence summary, and to extract one or more pairs, which exist only in the said second evaluation comment group, as a non-presence summary.

According to the present invention, due to that sentences are decomposed into words (i.e., morphemes or parts of speech), a comparison process can be performed by a pair unit, each pair includes a keyword and a part of speech qualifies or is qualified by its keyword, unlike a sentence/phrase unit, and thus summaries are created more accurately. In other words, in a sentence/phrase unit there are some blocks, which cannot properly be treated and which are included in a sentence/phrase due to delicate or slight differences of wordings, expressions, or modification relation structures. According to the present invention summaries can be produced more appropriately, because each sentence are divided into words and to make pairs of the words and each pair of words can be treated as a block which forms a meaningful block having a sort of a theme or a subject.

In still another embodiment of the document processing device according to the present invention,
the said extracting means selects one or more sentences, in which appearance frequencies of which are more than a predetermined threshold, from the extracted sentences as the presence summary and/or the non-presence summary,
or the said extracting means selects one or more phrases, in which appearance frequencies of which are more than a predetermined threshold, from the extracted phrases as the presence summary and/or the non-presence summary, or the said extracting means selects one or more pairs, in which appearance frequencies of which are more than a predetermined threshold, from the extracted pairs as the presence summary and/or the non-presence summary.

According to the present invention only high-frequency things (sentences, phrases or pairs) can be extracted, even if there are enormous number of evaluation comments or even if each comment has redundant descriptions or has very long texts, summary in reasonable size/length may be created. Namely by adjusting a threshold to appropriated value, length of the summary can be controlled to below a desired size.

In still another embodiment of the document processing device according to the present invention,
the said extracting means either eliminates predetermined one or more sentences from the extracted sentences, or eliminates one or more sentences, which is/are the highest or top several appearance frequency, from the extracted sentences,
or the said extracting means either eliminates predetermined one or more phrases from the extracted phrases, or eliminates one or more phrases, which is/are the highest or top several appearance frequency, from the extracted phrases,
or the said extracting means either eliminates predetermined one or more pairs from the extracted pairs of the attributes and the attribute values, or eliminates one or more pairs, which is/are the highest or top several appearance frequency, from the extracted pairs of the attributes and the attribute values.

Although almost evaluation comments have some sort of expressions for thanks and greetings or expressions of courtesy, which have mostly no useful or no meaningful information, according to the present invention such no meaningful information can efficiently and properly be excluded from each summary. Since in general such expressions for thanks and greetings or expressions of courtesy have the highest appearance frequency, statistics quantities of appearance frequencies can be used for eliminating such vain information from summaries without preparing in advance stereotyped sentences, expressions, words, phrases, or pairs for excluding.

In still another embodiment of the document processing device according to the present invention, the said plurality of evaluation subjects are sellers of e-commerce (e.g., users or exhibitors in electric auction web sites) and the said plurality of valuers are buyers of e-commerce (e.g., winning bidders in electric auction web sites), and wherein the said evaluation comments are evaluation comments on the sellers by the buyers (e.g., reviews of items, which are evaluations of attitudes/dealing/response/communications of exhibitors who are successfully bided).

There exists a great number of evaluation comments of many sellers by many buyers, according to the present invention such great number of evaluation comments can efficiently and properly be summarized.

By way of easy explanation the aspect of the present invention has been described as the devices, however it is understood that the present invention may be realized as methods corresponding to the systems, programs embodying the methods as well as a storage media storing the programs therein.

For example, according to another aspect of the present invention, there is provided a document processing method for summarizing evaluation comments using social relationships, the method comprises the steps of:
accessing a database, in which evaluation comments on a plurality of evaluation subjects by a plurality of valuers are stored therein, via network (such as the Internet);
when accessing a database for summarizing evaluation comments according to each evaluation subject, in which evaluation comments on a plurality of evaluation subjects by a plurality of valuers are stored therein, collecting or gathering evaluation comments aiming at a certain evaluation subject as a first evaluation comment group from the database, and collects evaluation comments, which are comments on evaluation subjects other than the said certain evaluation subject by valuers who provided evaluation comments on the said certain evaluation subject, as a second evaluation comment group from the database;
comparing the said first evaluation comments with the said second evaluation comments group by each valuer, and to extract one or more sentences in which the one or more sentences exist only in the said first evaluation comment group as a presence summary and to extract one or more sentences in which the one or more sentences exist only in the said second evaluation comment group as a non-presence summary by a calculating means (e.g., a CPU or an MPU);
storing the extracted non-presence summary and the non-presence summary as a summary in a storage; and
displaying the extracted non-presence summary and the non-presence summary as a summary on a display (e.g., a CRT or an LCD).

The method further comprises repeating the collecting step and the comparing step for every valuer and repeating whole of the steps for every evaluation subject.

In an embodiment of the document processing method according to the present invention, the method further comprises segmenting/dividing sentences included in the said first and second evaluation comment groups into phrases using a morpheme analysis technique by a calculating means,
and wherein the said comparing step compares the phrases of the said first evaluation comments group with the phrases of the said second evaluation comments group by each valuer, and to extract one or more phrases, which exist only in the said first evaluation comment group, as a presence summary, and to extract one or more phrases, which exist only in the said second evaluation comment group, as a non-presence summary.

In another embodiment of the document processing method according to the present invention, the method further comprises segmenting sentences included in the said first and second evaluation comment groups into pairs, each including an attribute having at least one predetermined keyword and an attribute value having at least one part of speech regarding the attribute, using a morpheme analysis technique by a calculating means,
and wherein the said comparing step compares the pairs of the said first evaluation comments group with the pairs of the said second evaluation comments group by each valuer, and to extract one or more pairs, which exist only in the said first evaluation comment group, as a presence summary, and to extract one or more pairs, which exist only in the said second evaluation comment group, as a non-presence summary by a calculating means.

In still another embodiment of the document processing method according to the present invention, the said comparing step selects one or more sentences/phrases/pairs, in which appearance frequencies of which are more than a predetermined threshold, from the extracted sentences/phrases/pairs as the presence summary and/or the non-presence summary.

In still another embodiment of the document processing method according to the present invention, the said comparing steps either eliminates predetermined one or more sentences/phrases/pairs from the extracted sentences/phrases/pairs, or eliminates one or more sentences/phrases/pairs, which is/are the highest or top several appearance frequency, from the extracted sentences/phrases/pairs.

In still another embodiment of the document processing method according to the present invention, the said plurality of evaluation subjects are sellers of e-commerce and the said plurality of valuers are buyers of e-commerce, and the said evaluation comments are evaluation comments on the sellers by the buyers.

In addition, according to another aspect of the present invention, there is provided a document processing program for executing a document processing method for summarizing evaluation comments using social relationships by a computer, the program comprises the steps of:
accessing a database, in which evaluation comments on a plurality of evaluation subjects by a plurality of valuers are stored therein, via network (such as the Internet);
when accessing a database for summarizing evaluation comments according to each evaluation subject, in which evaluation comments on a plurality of evaluation subjects by a plurality of valuers are stored therein, collecting evaluation comments aiming at a certain evaluation subject as a first evaluation comment group from the database, and collects evaluation comments, which are comments on evaluation subjects other than the said certain evaluation subject by valuers who provided evaluation comments on the said certain evaluation subject, as a second evaluation comment group from the database;
comparing the said first evaluation comments group with the said second evaluation comments group by each valuer, and to extract one or more sentences in which the one or more sentences exist only in the said first evaluation comment group as a presence summary and to extract one or more sentences in which the one or more sentences exist only in the said second evaluation comment group as a non-presence summary;
storing the extracted non-presence summary and the non-presence summary as a summary in a storage; and
displaying the extracted non-presence summary and the non-presence summary as a summary on a display (e.g., a CRT or an LCD).

In an embodiment of the document processing program according to the present invention, the program further comprises segmenting sentences included in the said first and second evaluation comment groups into phrases using a morpheme analysis technique,
and wherein the said comparing step compares the phrases of the said first evaluation comments group with the phrases of the said second evaluation comments group by each valuer, and to extract one or more phrases, which exist only in the said first evaluation comment group, as a presence summary, and to extract one or more phrases, which exist only in the said second evaluation comment group, as a non-presence summary.

In another embodiment of the document processing program according to the present invention, the program further comprises segmenting or dividing sentences included in the said first and second evaluation comment groups into pairs, each including an attribute having at least one predetermined keyword and an attribute value having at least one part of speech regarding the attribute, using a morpheme analysis technique,
and wherein the said comparing step compares the pairs of the said first evaluation comments group with the pairs of the said second evaluation comments group by each valuer, and to extract one or more pairs, which exist only in the said first evaluation comment group, as a presence summary, and to extract one or more pairs, which exist only in the said second evaluation comment group, as a non-presence summary.

In still another embodiment of the document processing program according to the present invention, the said comparing step selects one or more sentences/phrases/pairs, in which appearance frequencies of which are more than a predetermined threshold, from the extracted sentences/phrases/pairs as the presence summary and/or the non-presence summary.

In still another embodiment of the document processing program according to the present invention, the said comparing steps either eliminates predetermined one or more sentences/phrases/pairs from the extracted sentences/phrases/pairs, or eliminates one or more sentences/phrases/pairs, which is/are the highest or top several appearance frequency, from the extracted sentences/phrases/pairs.

In still another embodiment of the document processing program according to the present invention, the said plurality of evaluation subjects are sellers of e-commerce and the said plurality of valuers are buyers of e-commerce, and the said evaluation comments are evaluation comments on the sellers by the buyers.

### BRIEF DESCRIPTION OF THE DRAWINGS

FIG. 1 is a block diagram showing a basic configuration of an embodi-ment of the document processing device according to the present invention;

FIG. 2 is a conceptual diagram illustrating a concept of the present invention;

FIG. 3 is a schematic diagram representing a procedure for making a summary of an exhibitor A (i.e., evaluation subject) by means of a technique according to the present invention;

FIG. 4 is a schematic diagram depicting a procedure for finding differences between an evaluation comment on a target exhibitor for making a summary and other evaluation comments on other exhibitors from evaluation comments by a certain successful bidder;

FIG. 5 is a schematic diagram illustrating examples of attributes and attribute values used in the present invention;

FIG. 6 is a schematic table showing examples of pairs of attributes and parts of speech as attribute values used in the present invention;

FIG. 7 is a block diagram depicting a system configuration of an embodiment applicable for summarizing evaluation comments in an auction site of the document processing device according to the present invention;

FIG. 8 is a screen shot displaying the summary result from the document processing device according to the present invention;

FIG. 9 is a screen shot illustrating original evaluation comments on the target evaluation subject person of the summary result of FIG. 8; and

FIG. 10 is a screen shot representing original evaluation comments on other than the target subject person by a certain valuer B of the summary result of FIG. 8.

### DETAILED DESCRIPTION OF THE PREFERRED EMBODIMENTS

Several preferred embodiments of the document processing device according to the present invention will be described with reference to the accompanying drawings.

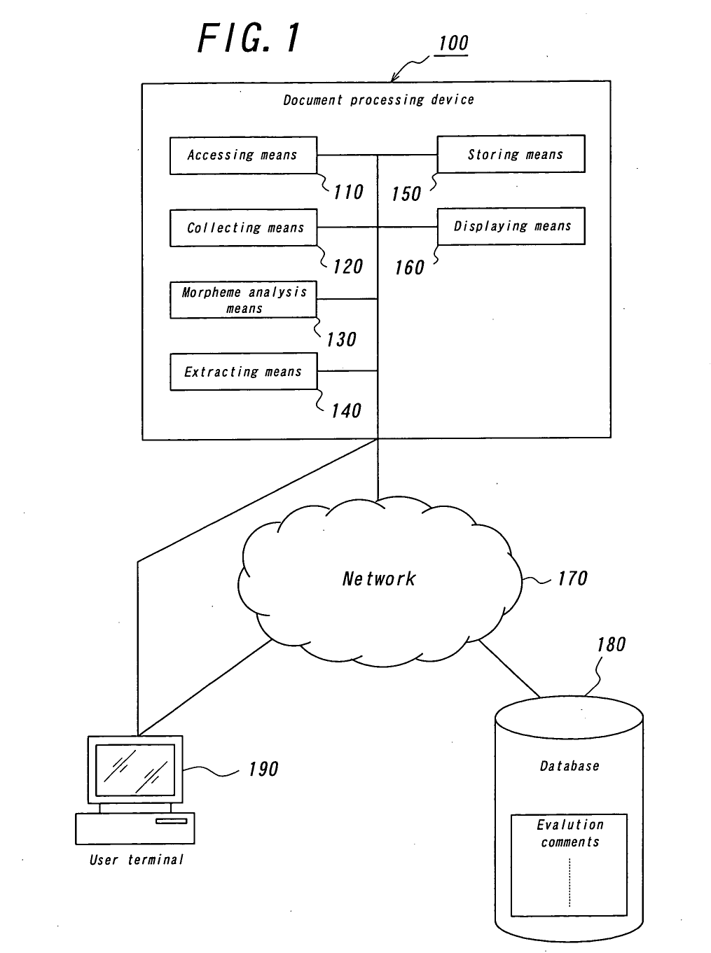

FIG. 1 is a block diagram showing a basic configuration of an embodiment of the document processing device according to the present invention. As shown in FIG. 1, a document processing device 100 according to the present invention comprises an accessing means 110, a collecting means 120, a morpheme analysis means 130, an extracting means 140, a storing means 150, and a displaying means 160. The document processing device is connected to a database(s) 180 (or a document server) and a user terminal(s) 190 via a network 170 (e.g., a LAN, a WAN, or the Internet).

The accessing means 110 accesses the database 180, in which a many number of evaluation comments on a plurality of evaluation subjects by a plurality of valuers are stored therein, via the network 170. In order to summarize evaluation comments by each evaluation subject, the collecting means 120 collects evaluation comments aiming at a certain evaluation subject as a first evaluation comment group from the database 180, and collects evaluation comments, in which these evaluation comments are comments on nay evaluation subjects other than the said certain evaluation subject by valuers who provided evaluation comments on the said certain evaluation subject as a second evaluation comment group from the database 180.

The morpheme analysis means 130 segments or divides sentences included in the said first and second evaluation comment groups into pairs of an attribute having at least one predetermined keyword and an attribute value having at least one part of speech regarding the attribute using a morpheme analysis technique. The extracting means 140 compares the pairs of the said first evaluation comments group with the pairs of the said second evaluation comments group by each valuer, and to extract one or more pairs, which exist only in the said first evaluation comment group, as a presence summary. Also the extracting means 140 extracts one or more pairs, which exist only in the said second evaluation comment group, as a non-presence summary by the comparison. The storing means 150 stores the extracted summaries by each valuer therein (e.g., in a hard disk). The displaying means 160 allows the user terminal 190 to display the result thereon to present the summary, in which overlapped pairs are wrapped into one for clearness, to a user. Since a form of pairs including parts of speech is in not an easy-to-understand form, that is user cannot directly understand what the information is, the present device may translate the pairs into corresponding phrases (e.g., a pairs “response-quick” is converted to a phrase “response is quick”) to display the translated phrases for easy-to-understand. Alternatively the pairs may be displayed as a form of original sentences or phrases containing the respective pairs.

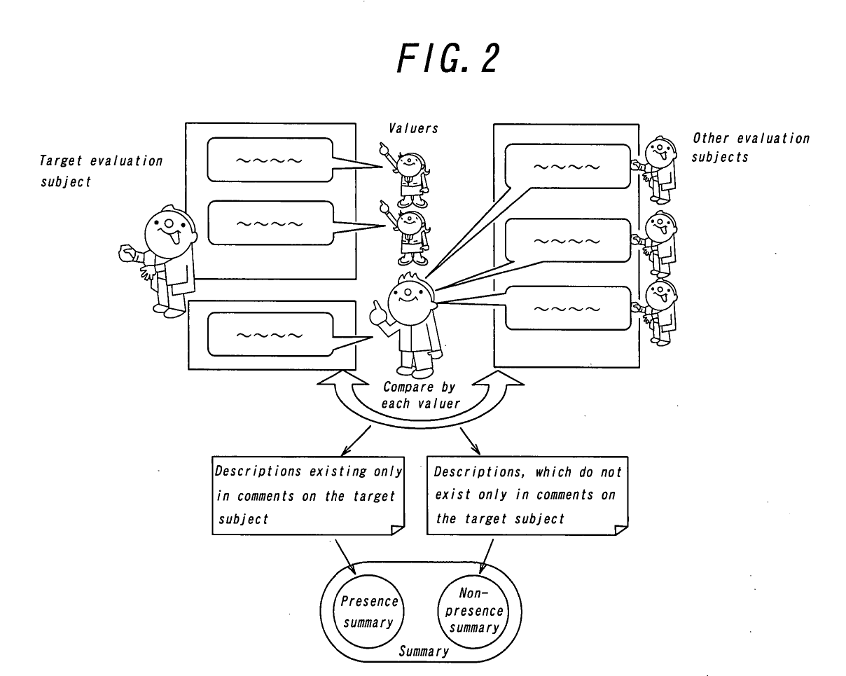

FIG. 2 is a conceptual diagram illustrating a concept of the present invention used in an auction as an example.

(1) In order to summarize evaluation comments on a certain exhibitor (who is called as an evaluation subject, a target subject, or an evaluation subject person herein), the technique according to the present invention examines not only evaluation comments on the target evaluation subject but also reviews on other evaluation subjects which are written by persons who wrote the comment for the target exhibitor. In other words, in the technique each of wining bidders (i.e., evaluators) who did deals with the target exhibitor is investigated one by one, and thus all evaluation comments on other than the target person, which are written by the respective wining bidders, are collected.

(2) The collected evaluation comments on other than the target exhibitor are compared with the collected evaluation comments on the target evaluation exhibitor by each wining bidder, to extract both descriptions only for the target exhibitor and descriptions which do not exist in only evaluation comments on the target exhibitor as two kinds of summaries (the former is called as “a presence summary” and the latter is called as “a non-presence summary” herein). The comparison about one target subject is repeated for every valuer and the results of summaries are packed into one summary.

According to the present invention, descriptions, in which wining bidder has intentionally written the descriptions and which show real minds or thoughts of the bidders, can be extracted as a presence summary. In addition, it may be presumed that the descriptions of the non-presence summary, which are usually used by the bidders but the descriptions are intentionally excluded to the reviews on the target exhibitor for any reason.

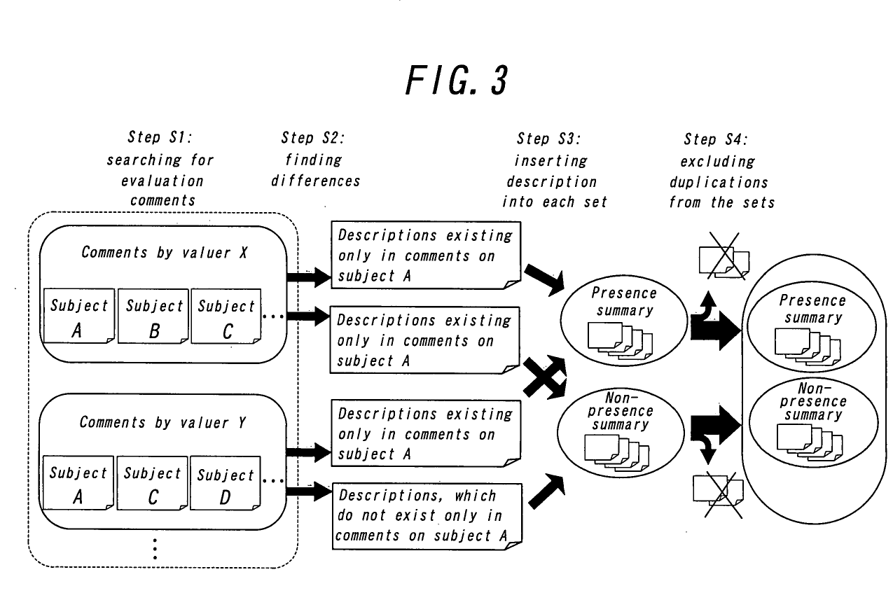

FIG. 3 is a schematic diagram representing a procedure for making a summary of an exhibitor A (i.e., an evaluation subject) by means of a technique according to the present invention.

Step S1: Searching for Evaluation Comments

As shown on step S1 in FIG. 2, the present technique searches for all evaluation comments on someone by a certain wining bidder who provided a review comment for a target exhibitor to be summarized. To search for evaluation comments, it is needed that name of the certain wining bidder and URLs of pages including respective evaluation comments by the certain wining bidder are retrieved from web pages containing evaluation comments on the target exhibitor for summarizing. These are retrieved based on a template from HTML documents. The template(s) is/are prepared to meet a format(s) of the auction site(s) in advance and contains rules such as “an h-ref attribute in an n-th <A> element is retrieved”.

Step S2: Finding Differences

As shown on step S2 in FIG. 2, the present technique finds and retrieves differences between evaluation comments on the target exhibitor and other evaluation comments on other exhibitors by comparing them. The differences are location differences of descriptions such that which descriptions (e.g., sentences, phrases, or pairs of attributes and attribute values) exist only in the evaluation comments on the target exhibitor and location differences of descriptions such that which descriptions do not exist only in the evaluation comments on the target exhibitor. How to find difference therebetween will be explained in detail later.

Step S3: Inserting Descriptions into Each Set

As shown on step S3 in FIG. 2, the present technique collects and inserts the differences included only in the evaluation comments on the target exhibitor in a set or group (which is referred as a “presence summary”) and collects and inserts the differences which is not included only in the evaluation comments on the target exhibitor in a set or group (which is referred as a “non-presence summary”).

Step S4: Excluding Duplication from the Sets

As shown on step S4 in FIG. 2, the present technique repeats steps S2 and S3 for respective exhibitors and wraps overlapped descriptions of the sets into one for clearness, that is duplicated descriptions are excluded from the respective sets.

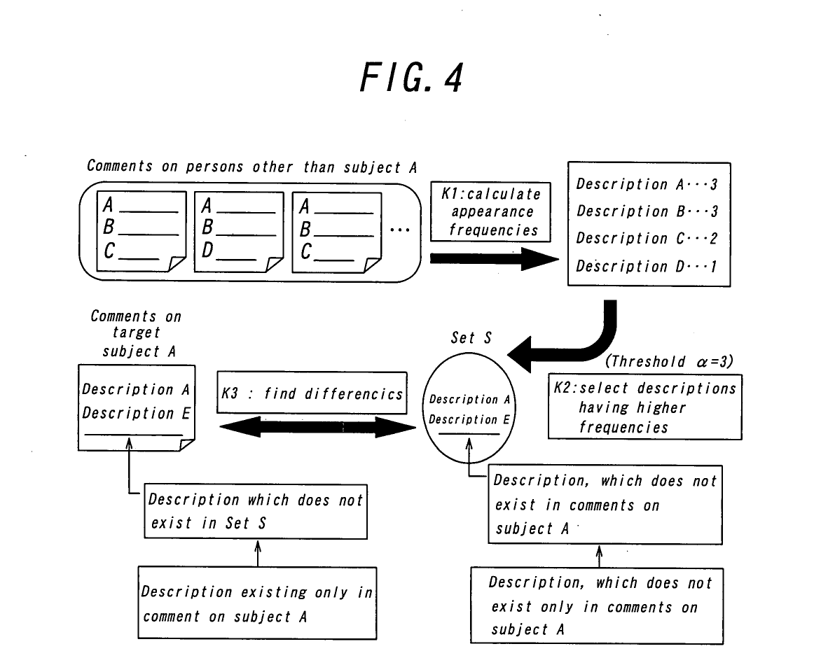

FIG. 4 is a schematic diagram depicting a procedure for finding differences between an evaluation comment on a target exhibitor for making a summary and other evaluation comments on other exhibitors from evaluation comments by a certain successful bidder;

As shown on step K1 in FIG. 4, appearance frequencies of descriptions in evaluation comments on other than the target exhibitor by wining bidders are obtained for every description. In this instance, each description is presented as a pair including both an attribute and its value, frequency is calculated for every pair of them. A method for extracting attribute and its value will be explained in detail later.

On step K2, descriptions (i.e., pairs) having higher appearance frequencies (which are more than a threshold a) are selected from the collected evaluation comments and the selected descriptions are considered as a set “S” of pairs.

On step K3, two kinds of differences between members of the set and review comments on the target subject are found out as follows:
Searching for one or more description, which do not exist only the set S, form descriptions contained in evaluation comments on the target exhibitor; and
Searching for one or more members, which do not exist in the evaluation comments on the target exhibitor, from the respective members of the set S.
   Method for Extracting an Attribute and an its Value

Descriptions in evaluation comments are represented as sets, each of which include both an attribute and an attribute value, the attribute includes one or more keywords representing a topic of the description and the attribute value includes one or more keywords representing the topic. According to an investigation conducted by the present inventors about 180 of evaluation comments in an actual network auction site, it is found that the attributes are categorized into thirteen groups and the attribute values are of great variety.

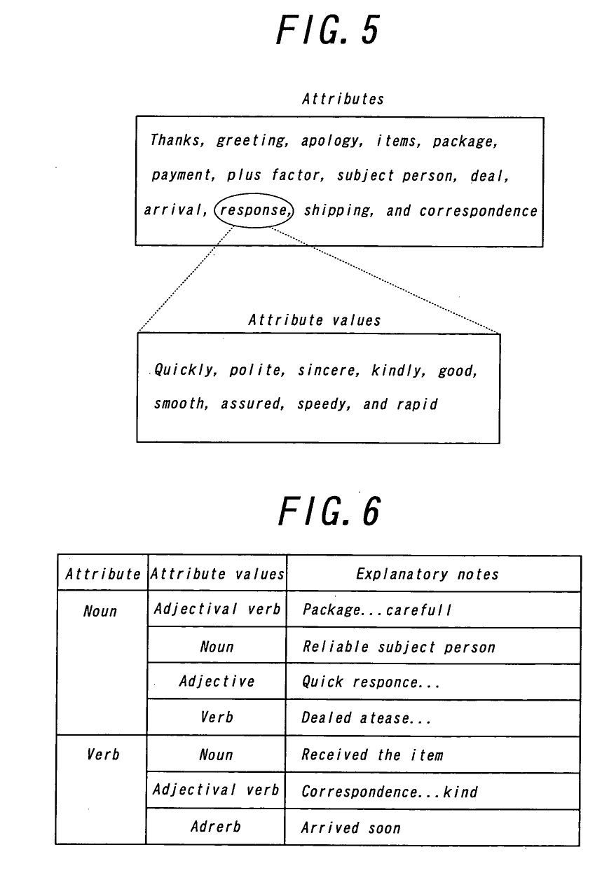

FIG. 5 is a schematic diagram illustrating examples of attributes and attribute values used in the present invention. As shown in FIG. 5, all attributes, which are found in the above our investigation in the auction site, and attribute values, which relate to an attribute “response” as examples of the attribute values, are presented.

Now, a procedure for extracting an attribute and an attribute values is explained below.

(1) Evaluation comments are processed by a morpheme analysis technique to be expressed as words or morphemes. Predetermined keywords (in this technique, if needed, a synonym dictionary can be included in the document processing device or be referred) for each attribute are compared with the words in the comments to perform a keyword-matching, and thus each attribute to be extracted and its location can be determined.

(2) A word, which is the closest to each attribute position, is selected from predetermined particular words (i.e. several parts of speech) for each attribute. The selected word is regarded as an “attribute value”. According to an investigation conducted by the present inventors about 180 of evaluation comments in an actual network auction site, it is found that which parts of speech are applicable to attribute values in evaluation comments as shown in FIG. 6. That is, when an attribute is a noun, its value can be an adjectival verb, a noun, an adjective, or a verbal. In addition, when an attribute is a verb, its value can be a noun, an adjectival verb, or an adverb. These parts of speech are listed in order of descending appearance frequency in the table of FIG. 6. If two attribute values (parts of speech) having the same distant from the target attribute are found, one of the two attribute values is selected in the order corresponding to the list of FIG. 6.

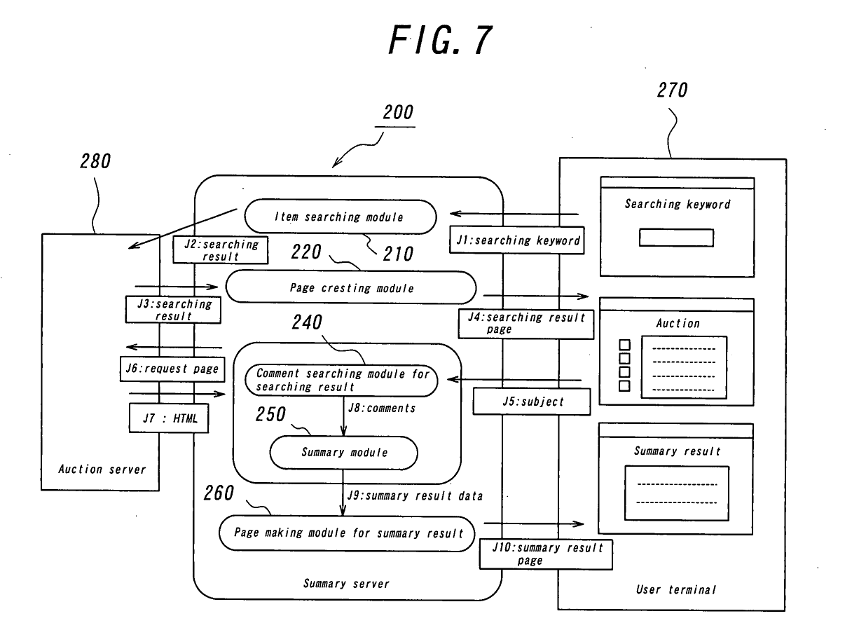

FIG. 7 is a block diagram depicting a system configuration of an embodiment applicable for summarizing evaluation comments in an auction site of the document processing device according to the present invention.

As shown in FIG. 7, there is provided a summary server 200 for generating summaries from evaluation comments, the summary server 200 comprises a document processing device according to the present information. A user terminal 270 accesses the summary server 200 instead of an auction server 280 and receives some summaries of evaluation comments from the summary server 200. In this way, third party not only business owner of a network auction sites can provides summarizing services in a form of ASP (application service provider). In this embodiment, programs on the summary server 200 are programs implemented either by JAVA codes or as JAVA serylets. The program modules implemented by JAVA codes act as functions which summarize review comments and the program modules as JAVA serylets act as functions which communicate with user terminals (i.e., web browsers on them). A flow of providing a summary of review comments is described below.

A searching keyword for an item which is interested in is inputted into the user terminal 270 by a user and the inputted data is transmitted therefrom to the summary server 200 (step J1). An item searching module 210 in the server 200 receives the searching keyword from the terminal 270 and the data, as it stands, is transferred therefrom to the auction server 280 (step J2) and then the auction server 280 transmits an HTML document as searching results to a page creating module 220 for creating a page including searching result (step J3). The page creating module 220 in the server embeds check boxes for selecting a desired target exhibitor into the HTML document and transferred it as result page to the user terminal 270 (step J4).

The user selects a desired target exhibitor, whom the user want to investigate a summaries thereof, by checking one of the boxes (step J5) on the user terminal 270. A comment searching module 240 for searching and collecting evaluation comments starts to search and collect evaluation comments needed for summarizing from evaluation comments regarding the selected target exhibitor. The comment searching module 240 request for searching the needed pages to the auction server 280 (step J6) and receives HTML documents as searching results (step J7), these two steps are repeated till the end of the searching for the needed information. After the searching for the evaluation comments is ended, the comment searching module 240 passes the all collected evaluation comments to a summary module 250 (step J8). Then, the summary module 250 produces summaries (a presence summary and a non-presence summary) from the all evaluation comments using the technique according to the present invention and transfers data containing the summary results to a page making module 260 for making a page in which the summary results are formatted for viewing (step J9). The page making module 260 in the server 200 makes a summary result page from the summary results data and transferred it to user terminal 270 (step J10). The user terminal 270 presents the received summary page to the user.

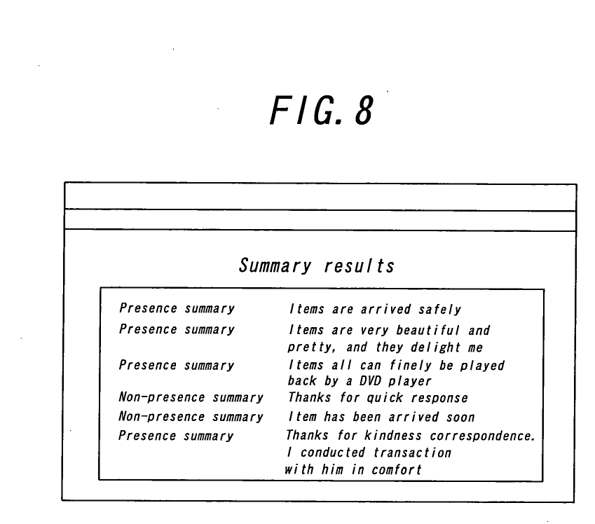

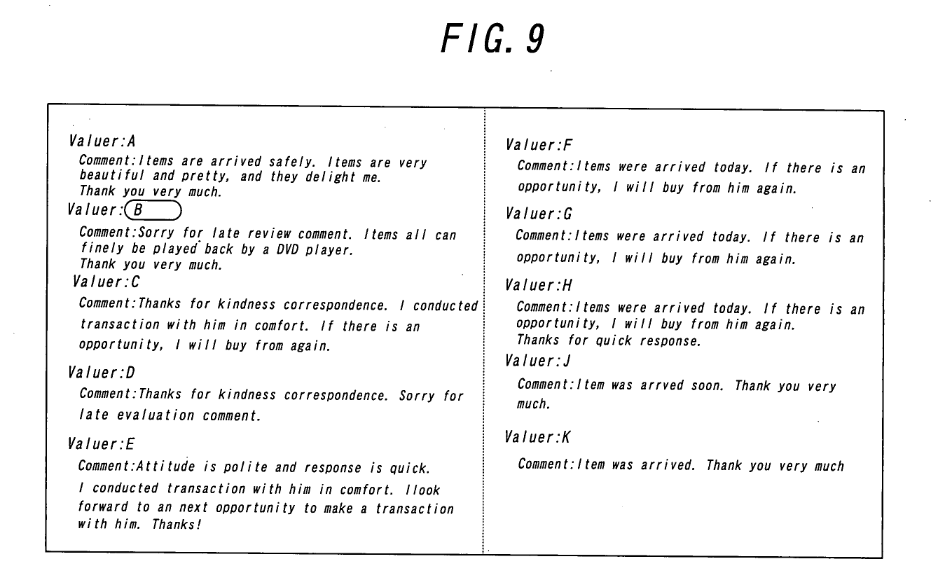

FIG. 8 is a screen shot displaying the summary result from the document processing device according to the present invention, and FIG. 9 is a screen shot illustrating a part of original evaluation comments on the target evaluation subject person of the summary result of FIG. 8.

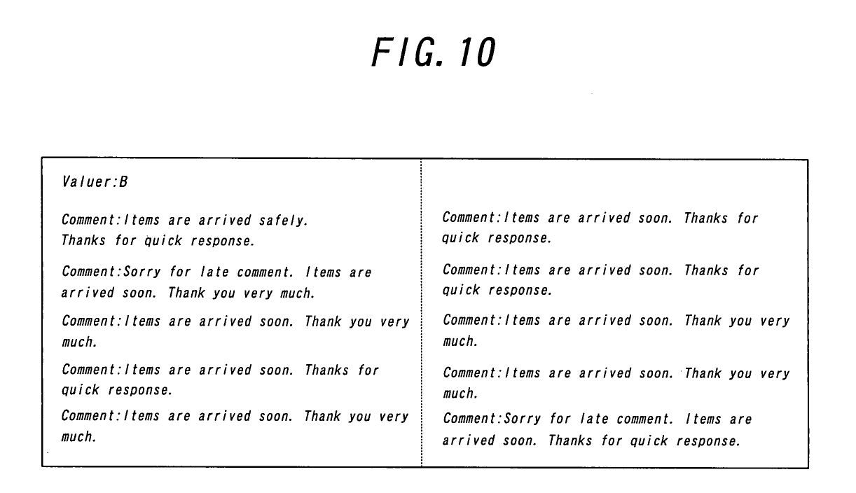

If trying to summarize evaluation comments as shown in FIG. 9 as it is, user finds it difficult to understand which description is useful for representing respective exhibitors. Therefore summarizing the evaluation comments as it is contributes little to user's investigations. According to the present technique, the technique casts a spotlight on an encircled certain valuer “B” as a wining bidder (As shown in FIG. 10, evaluation comment, by the valuer (wining bidder) B, on non-target persons, i.e., persons other than the target exhibitor). When comparing description by the valuer B in FIG. 9 and all evaluation comments by valuer B in FIG. 10, it is found that there exists a description “they all can finely be played back by a DVD player” written by valuer B in FIG. 9 and there does not exist such kind of description in FIG. 10. Therefore, this description is written for only the target exhibitor, it takes the form of a presence summary on the summary in FIG. 8. In such way, a description, which is written with considerable special feeling of a valuer, can be remained in a summary according to the present invention. Here, in reference to FIG. 10, it is fount that there exists many descriptions such as “The item arrived immediately” and “Thanks for quick response”. However, since there does not exist such two kinds of descriptions in evaluation comment by the valuer B in FIG. 9, such descriptions are not written for only the target exhibitor by the valuer B. Therefore, such descriptions appear on the summary in FIG. 8 as a non-presence summary. In this case, it is expected that such descriptions do not applicable to the target exhibitor by analogy with a difference therebetween. That is, it is deduced that “response is not quick” and “arrival of item is delayed”.

Now, referring FIG. 10 again, it is found that valuer (wining bidder) B repeatedly uses substantially same descriptions (most of which are expressions for courtesy). In the many number of cases, it is conceived that a valuer prepare the text as a template for a review comment in advance, he or she uses it by copying and pasting from the template. Therefore, instead of summarizing evaluation comments as it is on the target exhibitor, comparing evaluation comments on the target exhibitor by a certain valuer with evaluation comments on other than the target exhibitor by the certain valuer can easily exclude such similar descriptions. In addition, there is a description, which is written for only the target exhibitor and which is not written for other exhibitors, it is conceived that the description is provided with any special feelings and the description expresses a real intention of a valuer. In this regard, such description can easily be extracted by comparing them by each wining bidder. In addition, there is a description for other than the target, which is intentionally not provided for the target exhibitor, it is conceived that the description is not written by any reason. When such description “non-presence summary” (i.e., which is an implicit evaluation comment and is an indirect evaluation comment on the target subject) is presented to users, each user can deduce veiled real opinions of valuers from such displayed description.

While the present invention has been described with respect to some embodiments and drawings, it is to be understood that the present invention is not limited to the above-described embodiments, and modifications and drawings, various changes and modifications may be made therein, and all such changes and modifications are considered to fall within the scope of the invention as defined by the appended claims. However, the present invention is mainly explained as embodiments applicable to summarize review comments in the auction site, the present invention is not limited to such a field and covers general evaluation comments on any subjects (e.g., persons, companies, services, or stores), which are evaluated by one or more persons (i.e., customers). For example, the present invention is applicable to various evaluation comments such as review comments on restaurants or virtual shops on the Web as well as items, or services, which are traded over the Internet.

1. A document processing device for summarizing evaluation comments using social relationships, comprising:
collecting means for, when accessing a database in which evaluation comments on a plurality of evaluation subjects by a plurality of valuers are stored therein for summarizing evaluation comments according to each evaluation subject, collecting evaluation comments aiming at a certain evaluation subject as a first evaluation comment group from the database, and for collecting evaluation comments, which t are comments on evaluation subjects other than the said certain evaluation subject by valuers who provided evaluation comments on the said certain evaluation subject, as a second evaluation comment group from the database;
extracting means for comparing the said first evaluation comments group with the said second evaluation comments group by each valuer, and to extract one or more sentences in which the one or more sentences exist only in the said first evaluation comment group as a presence summary and to extract one or more sentences in which the one or more sentences exist only in the said second evaluation comment group as a non-presence summary.

2. The document processing device according to claim 1, the device further comprises morpheme analysis means for segmenting sentences included in the said first and second evaluation comment groups into phrases using a morpheme analysis technique,
and wherein the said extracting means compares the phrases of the said first evaluation comments group with the phrases of the said second evaluation comments group by each valuer, and to extract one or more phrases, which exist only in the said first evaluation comment group, as a presence summary, and to extract one or more phrases, which exist only in the said second evaluation comment group, as a non-presence summary.

3. The document processing device according to claim 1, the device further comprises morpheme analysis means for segmenting sentences included in the said first and second evaluation comment groups into pairs, each including an attribute having at least one predetermined keyword and an attribute value having at least one part of speech regarding the attribute, using a morpheme analysis technique,
and wherein the said extracting means compares the pairs of the said first evaluation comments group with the pairs of the said second evaluation comments group by each valuer, and to extract one or more pairs, which exist only in the said first evaluation comment group, as a presence summary, and to extract one or more pairs, which exist only in the said second evaluation comment group, as a non-presence summary.

4. The document processing device according to claim 1, wherein the said extracting means selects one or more sentences, in which appearance frequencies of which are more than a predetermined threshold, from the extracted sentences as the presence summary and/or the non-presence summary.

5. The document processing device according to claim 4, wherein the said extracting means either eliminates predetermined one or more sentences from the extracted sentences, or eliminates one or more sentences, which is/are the highest or top several appearance frequency, from the extracted sentences.

6. The document processing device according to claim 2, wherein the said extracting means selects one or more phrases, in which appearance frequencies of which are more than a predetermined threshold, from the extracted phrases as the presence summary and/or the non-presence summary.

7. The document processing device according to claim 6, wherein the said extracting means either eliminates predetermined one or more phrases from the extracted phrases, or eliminates one or more phrases, which is/are the highest or top several appearance frequency, from the extracted phrases.

8. The document processing device according to claim 3, wherein the said extracting means selects one or more pairs, in which appearance frequencies of which are more than a predetermined threshold, from the extracted pairs as the presence summary and/or the non-presence summary.

9. The document processing device according to claim 8, wherein the said extracting means either eliminates predetermined one or more pairs from the extracted pairs of the attributes and the attribute values, or eliminates one or more pairs, which is/are the highest or top several appearance frequency, from the extracted pairs of the attributes and the attribute values.

10. The document processing device according to claim 1, wherein the said plurality of evaluation subjects are sellers of e-commerce and the said plurality of valuers are buyers of e-commerce, and wherein the said evaluation comments are evaluation comments on the sellers by the buyers.

11. A document processing method for summarizing evaluation comments using social relationships, the method comprising the steps of:
when accessing a database for summarizing evaluation comments according to each evaluation subject, in which evaluation comments on a plurality of evaluation subjects by a plurality of valuers are stored therein, collecting evaluation comments aiming at a certain evaluation subject as a first evaluation comment group from the database, collecting evaluation comments, which are comments on evaluation subjects other than the said certain evaluation subject by valuers who provided evaluation comments on the said certain evaluation subject, as a second evaluation comment group from the database;
comparing the said first evaluation comments with the said second evaluation comments group by each valuer, and to extract one or more sentences in which the one or more sentences exist only in the said first evaluation comment group as a presence summary and to extract one or more sentences in which the one or more sentences exist only in the said second evaluation comment group as a non-presence summary.

12. The document processing method according to claim 11, the method further comprises segmenting sentences included in the said first and second evaluation comment groups into phrases using a morpheme analysis technique,
and wherein the said comparing step compares the phrases of the said first evaluation comments group with the phrases of the said second evaluation comments group by each valuer, and to extract one or more phrases, which exist only in the said first evaluation comment group, as a presence summary, and to extract one or more phrases, which exist only in the said second evaluation comment group, as a non-presence summary.

13. The document processing method according to claim 11, the method further comprises segmenting sentences included in the said first and second evaluation comment groups into pairs, each including an attribute having at least one predetermined keyword and an attribute value having at least one part of speech regarding the attribute, using a morpheme analysis technique,
and wherein the said comparing step compares the pairs of the said first evaluation comments group with the pairs of the said second evaluation comments group by each valuer, and to extract one or more pairs, which exist only in the said first evaluation comment group, as a presence summary, and to extract one or more pairs, which exist only in the said second evaluation comment group, as a non-presence summary.

14. The document processing method according to claim 11, wherein the said comparing step selects one or more sentences, in which appearance frequencies of which are more than a predetermined threshold, from the extracted sentences as the presence summary and/or the non-presence summary.

15. The document processing method according to claim 14, wherein the said comparing steps either eliminates predetermined one or more sentences from the extracted sentences, or eliminates one or more sentences, which is/are the highest or top several appearance frequency, from the extracted sentences,

16. The document processing method according to claim 12, wherein the said comparing step selects one or more phrases, in which appearance frequencies of which are more than a predetermined threshold, from the extracted phrases as the presence summary and/or the non-presence summary.

17. The document processing method according to claim 16, wherein the said comparing step either eliminates predetermined one or more phrases from the extracted phrases, or eliminates one or more phrases, which is/are the highest or top several appearance frequency, from the extracted phrases.

18. The document processing method according to claim 13, wherein the said comparing step selects one or more pairs, in which appearance frequencies of which are more than a predetermined threshold, from the extracted pairs as the presence summary and/or the non-presence summary.

19. The document processing method according to claim 18, wherein the said comparing step either eliminates predetermined one or more pairs from the extracted pairs of the attributes and the attribute values, or eliminates one or more pairs, which is/are the highest or top several appearance frequency, from the extracted pairs of the attributes and the attribute values.

20. The document processing method according to claim 11, wherein the said plurality of evaluation subjects are sellers of e-commerce and the said plurality of valuers are buyers of e-commerce, and wherein the said evaluation comments are evaluation comments on the sellers by the buyers.

21. A document processing program for executing a document processing method for summarizing evaluation comments using social relationships, the program comprising the steps of:
when accessing a database for summarizing evaluation comments according to each evaluation subject, in which evaluation comments on a plurality of evaluation subjects by a plurality of valuers are stored therein, collecting evaluation comments aiming at a certain evaluation subject as a first evaluation comment group from the database, and collects evaluation comments, which are comments on evaluation subjects other than the said certain evaluation subject by valuers who provided evaluation comments on the said certain evaluation subject, as a second evaluation comment group from the database;
comparing the said first evaluation comments group with the said second evaluation comments group by each valuer, and to extract one or more sentences in which the one or more sentences exist only in the said first evaluation comment group as a presence summary and to extract one or more sentences in which the one or more sentences exist only in the said second evaluation comment group as a non-presence summary.

22. The document processing program according to claim 21, the program further comprises segmenting sentences included in the said first and second evaluation comment groups into phrases using a morpheme analysis technique,
and wherein the said comparing step compares the phrases of the said first evaluation comments group with the phrases of the said second evaluation comments group by each valuer, and to extract one or more phrases, which exist only in the said first evaluation comment group, as a presence summary, and to extract one or more phrases, which exist only in the said second evaluation comment group, as a non-presence summary.

23. The document processing program according to claim 21, the program further comprises segmenting sentences included in the said first and second evaluation comment groups into pairs, each including an attribute having at least one predetermined keyword and an attribute value having at least one part of speech regarding the attribute, using a morpheme analysis technique,
and wherein the said comparing step compares the pairs of the said first evaluation comments group with the pairs of the said second evaluation comments group by each valuer, and to extract one or more pairs, which exist only in the said first evaluation comment group, as a presence summary, and to extract one or more pairs, which exist only in the said second evaluation comment group, as a non-presence summary.

24. The document processing program according to claim 21, wherein the said comparing step selects one or more sentences, in which appearance frequencies of which are more than a predetermined threshold, from the extracted sentences as the presence summary and/or the non-presence summary.

25. The document processing program according to claim 24, wherein the said comparing steps either eliminates predetermined one or more sentences from the extracted sentences, or eliminates one or more sentences, which is/are the highest or top several appearance frequency, from the extracted sentences.

26. The document processing program according to claim 22, wherein the said comparing step selects one or more phrases, in which appearance frequencies of which are more than a predetermined threshold, from the extracted phrases as the presence summary and/or the non-presence summary.

27. The document processing program according to claim 26, wherein the said comparing step either eliminates predetermined one or more phrases from the extracted phrases, or eliminates one or more phrases, which is/are the highest or top several appearance frequency, from the extracted phrases.

28. The document processing program according to claim 23, wherein the said comparing step selects one or more pairs, in which appearance frequencies of which are more than a predetermined threshold, from the extracted pairs as the presence summary and/or the non-presence summary.

29. The document processing program according to claim 28, wherein the said comparing step either eliminates predetermined one or more pairs from the extracted pairs of the attributes and the attribute values, or eliminates one or more pairs, which is/are the highest or top several appearance frequency, from the extracted pairs of the attributes and the attribute values.

30. The document processing program according to claim 21, wherein the said plurality of evaluation subjects are sellers of e-commerce and the said plurality of valuers are buyers of e-commerce, and wherein the said evaluation comments are evaluation comments on the sellers by the buyers.
